(19) United States
(12) Patent Application Publication
(10) Pub. No.: US 2026/0104685 A1
(43) Pub. Date: Apr. 16, 2026

(54) Health and Energy Co-Optimization in Building Monitoring

(71) Applicant: 9 Foundations, Inc., Chestnut Hill, MA (US)

(72) Inventors: Joseph G. ALLEN, Chestnut Hill, MA (US); Emily R. JONES, Arlington, MA (US); Shivani R. PARIKH, Brookline, MA (US)

(73) Assignee: 9 Foundations, Inc., Chestnut Hill, MA (US)

(21) Appl. No.: 19/357,998

(22) Filed: Oct. 14, 2025

Related U.S. Application Data
(60) Provisional application No. 63/706,152, filed on Oct. 11, 2024.

(51) Int. Cl. G05B 15/02; F24F 11/65; F24F 110/10; F24F 110/70; F24F 120/10

(52) U.S. Cl. CPC G05B 15/02; F24F 11/65; F24F 2110/10; F24F 2110/70; F24F 2120/10

(57) ABSTRACT

Systems and methods for health and energy co-optimization in building monitoring are disclosed herein, including methods and systems for monitoring a building and automatically identifying opportunities to realize energy savings without comprising the health, comfort, and productivity of building occupants. According to at least one aspect of the disclosure, machine learning methods may be applied to sensor data indicating one or more parameters related to indoor air quality (IAQ) of a building (such as carbon dioxide data and indoor air temperature data) to determine an estimate of the timing of building occupancy and an estimate of the timing of building operations. Based on these estimates, various scenarios may be identified, including time periods representing incidents of extended operations or extended occupancy. In various implementations, recommendations may be generated to adjust building systems based on the identified incidents and IAQ performance indicators for the time period. For example, such recommendations may be to change a mode of building operation at a particular time.

### RELATED APPLICATIONS

This application claims priority to U.S. Provisional Ser. No. 63/706,152 , filed Oct. 11, 2024, the content of which is incorporated herein by reference in its entirety.

### TECHNICAL FIELD

The present disclosure relates to the building environment management industry and, more particularly, to systems for health and energy co-optimization in building monitoring.

BACKGROUND OF THE DISCLOSURE Indoor air factors of a building (e.g., carbon-dioxide or CO₂ concentration, fine particulate matter or PM_{2.5} concentration, air temperature, etc.) can impact the health, comfort, and productivity of the occupants of the building. Monitoring the building can help in identifying problems associated with the building and determining the corresponding solutions. This can be done by installing various sensors (e.g., CO₂ sensors, PM_{2.5} sensors, temperature sensors, etc.) that can make real-time spot measurements of building conditions. The real-time spot measurements can assist with assessing the air conditions of the building, provided that the raw data are combined with additional information to aid in the interpretation of that data. Some conventional systems that utilize multiple sensors to determine real-time indoor air quality are challenged by the large amount of sensor data and thus often use techniques based on one-time spot measurements, which are unable to determine and identify long-term trends in building air quality.

Moreover, the low-cost indoor air quality (IAQ) sensors that are used in conventional systems are installed in buildings primarily to capture the benefits of enhanced health, comfort, and productivity that accompany optimal IAQ. The data from these sensors are not used to identify misalignment between building occupancy and operations, and corresponding implications for building energy savings. While techniques for performing energy audits exist, such techniques typically require access to energy data or integration with a building management system. These techniques also tend to focus primarily on energy savings without considering implications for potential occupant health, comfort, and productivity.

Accordingly, there is a need for an improved method and system for intelligent building monitoring that is able to automatically identify opportunities for energy savings that do not compromise occupant health, comfort, and productivity in buildings.

### SUMMARY OF THE DISCLOSURE

Aspects of this disclosure relate to various embodiments of methods and systems for health and energy co-optimization in building monitoring. According to at least one aspect of this disclosure, the methods and systems are configured to monitor a building and automatically identify opportunities to realize energy savings without comprising the health, comfort, and productivity of building occupants. In various implementations, sensor data indicating one or more parameters related to indoor air quality (IAQ) of a building may be received for a given time period, including, for example, carbon dioxide data and indoor air temperature data for the building. Using the sensor data, an estimate of the timing of building occupancy and an estimate of the timing of building operations may be determined. Based on these estimates, various scenarios may be identified, including time periods representing incidents of extended operations or extended occupancy. As used herein, incidents of “extended operations” may refer to incidents where the building is detected as operating while unoccupied, and incidents of “extended occupancy” may refer to incidents where building is detected as not operating while occupied. In various implementations, recommendations may be generated to adjust building systems based on the identified incidents and IAQ performance indicators for the time period. For example, such recommendations may be to change a mode of building operation at a particular time.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example system configured for health and energy co-optimization in building monitoring, according to one or more aspects described herein;

FIG. 2 depicts an example implementation of the system depicted in FIG. 1 for health and energy co-optimization by monitoring indoor air factors of a space, according to one or more aspects described herein;

FIG. 3 depicts a view of an example output provided by a system for monitoring indoor air factors of a space, according to one or more aspects described herein; and

FIG. 4 depicts an example process for monitoring a building and automatically identifying opportunities to realize energy savings without comprising the health, comfort, and productivity of building occupants, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention.

The invention described herein relates to systems and methods for monitoring a building using low-cost indoor air quality (IAQ) sensors and automatically identifying opportunities to realize energy savings without comprising the health, comfort, and productivity of building occupants. The systems and methods described herein may be configured to automatically identify such opportunities for energy savings in building(s) using data from low-cost IAQ sensors. In various implementations, the methods described herein may be implemented in a spatial monitoring system for monitoring indoor air factors of a space. In various implementations, the methods described herein may be implemented via a computer system comprising one or more processors, a memory, and/or one or more other components.

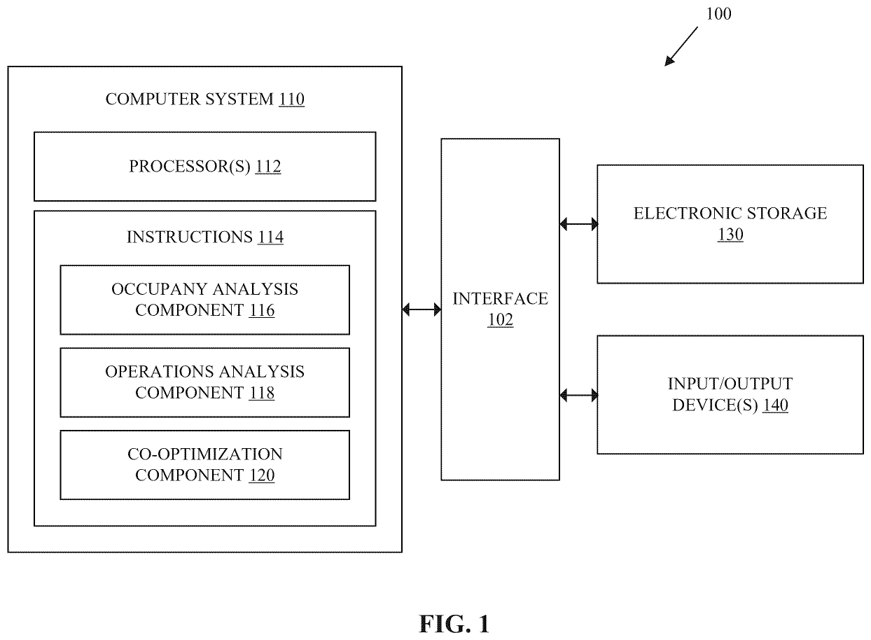

FIG. 1 illustrates an example of a system configured for health and energy co-optimization in building monitoring, according to one or more aspects described herein. In various implementations, system 100 may include one or more of interface 102, a computer system 110, electronic storage 130, input/output device(s) 140, and/or other components. In various implementations, computer system 110 may include one or more physical processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via one or more input/output device(s) 140. For example, one or more input/output device 140 may include one or more sensors, such as low-cost IAQ sensors and/or other sensors positioned within or around a building (or zone of interest) and used to monitor indoor air-quality, occupancy, operation, and/or other aspects of the building (or zone of interest), as described herein.

In various implementations, physical processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific integrated circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of an occupancy analysis component 116, an operations analysis component 118, a co-optimization component 120 and/or other computer program components. As used herein, for convenience, the various computer readable instructions 114 will be described as performing an operation, when, in fact, the various instructions program the processor(s) 112 (and therefore system 100) to perform the operation.

System 100 may be configured to perform the methods described herein. In various implementations, the methods described herein may comprise utilizing measurements taken by a set of low-cost IAQ sensors in a building over a period of time and, for each day in a period of time, producing an estimate of the time and duration of operation of the building's HVAC system(s) and/or an estimate of the time and duration the building is occupied. For ease of understanding, the “operation of the building's HVAC system(s)” may be simply referred to as “operations,” and the “time and duration of operation of the building's HVAC system(s)” may be simply referred to as “time and duration of operation.” Notably, however, the techniques described herein related to “time and duration of operation” may similarly be applied to the time and duration a building's HVAC system is in an occupied mode as opposed to a setback mode, or vice versa. For example, techniques described herein for determining a building's time and duration of operation may similarly (or instead) be used to determine the time and duration a building's HVAC system is in one or more particular modes of operation.

In various implementations, the methods may further include evaluating whether the hours of operation and/or hours of occupancy are aligned for the building. In various implementations, the methods may further include flagging, based on the estimated hours of operation and/or hours of occupancy, the days when operations extend substantially longer than occupancy and/or the days when occupancy extends substantially longer than operations. Periods of time when operations extend substantially longer than occupancy may represent opportunities for energy savings. Periods of time when occupancy extends substantially longer than operations may represent risks to occupant health, comfort, or productivity, or opportunities to update building operations to better support occupant health, comfort, and productivity. In various implementations, the percentage of time (over a period of time) where operations extend substantially longer than occupancy and occupancy extends substantially longer than operations may be determined and evaluated for each building. Buildings with a high percentage of time when operations extend substantially longer than occupancy may be flagged as buildings where energy savings opportunities may exist. Conversely, buildings with a high percentage of time when occupancy extends substantially longer than operations may be flagged as buildings where opportunities to protect health, comfort, and productivity may exist. In some implementations, these results may be presented as a heat map. While described herein with respect to buildings, the same method (and associated techniques) may be similarly applied to floors or spaces (e.g., ventilation zones) in a building that are served by a single HVAC system or controlled by a single thermostat. In such implementations, the methods may be similar, but the results may flag ventilation zones within a building where energy savings opportunities exist. In various implementations, the methods may additionally determine estimated temperature setpoints for a building or space within a building. Buildings with estimated temperature setpoints that vary substantially from expected temperature setpoints may have opportunities for energy savings.

In various implementations, the low-cost IAQ sensor parameters used to evaluate buildings (and/or smaller spaces within a building) may include carbon dioxide (CO₂), total volatile organic compounds (TVOCs), fine particulate matter (PM_{2.5}), air temperature, and/or relative humidity (RH), and/or other parameters.

In various implementations, the method may include selecting (or identifying) a period of time for analysis. For example, the period of time for analysis may comprise a number of days, a number of weeks, a number of months, and/or any other identifiable period of time. In an example implementation, a period of time selected for analysis may comprise a month.

In various implementations, the methods described herein may be implemented in combination with one or more steps of methods for monitoring and assessing the indoor air-quality of a building. For example, in various implementations, the methods (and techniques) described herein may be implemented in a spatial monitoring system, via a computer system, and/or in combination with one or more steps of methods for monitoring and assessing the indoor air-quality of a building as each are described in U.S. patent application Ser. No. 18/137,979, titled “Intelligent Building Monitoring,” filed Apr. 21, 2023, and/or U.S. patent application Ser. No. 18/338,871, titled “Intelligent Building Monitoring,” filed Jun. 21, 2023, the content of each of which is hereby incorporated by reference herein in their entirety.

Notably, techniques and processes are described herein for use in monitoring indoor air quality, occupancy, operation, and/or other aspects of a building. However, it should be appreciated by a person having ordinary skill in the art that the same techniques and processes may similarly be performed to monitor indoor air quality, occupancy, operation, and/or other aspects of other areas or zones of interest.

In various implementations, the one or more sensors may transmit sensor data representative of the detected air factors to computer system 110, for example, for use by occupancy analysis component 116, operations analysis component 118, and co-optimization component 120 to perform the methods described herein. In various implementations, the methods described herein may include, for each building, aggregating data from one or more sensors used to monitor indoor air-quality, occupancy, operation, and/or other aspects of a building. For example, the one or more sensors may comprise low-cost IAQ sensors. The data aggregated from the one or more sensors may include, for example, data indicating CO₂, PM_{2.5}, TVOC, temperature, RH, and/or other parameters. In some implementations, data for each building may be aggregated into parameter-specific time averages (e.g., 30-minute averages) and smoothed using a rolling mean. In some implementations, data quality checks on the data may be performed before the data is aggregated. For each parameter, first, second, and third derivatives may be calculated, and the derivatives at each timepoint may be labeled as statistically significant or not.

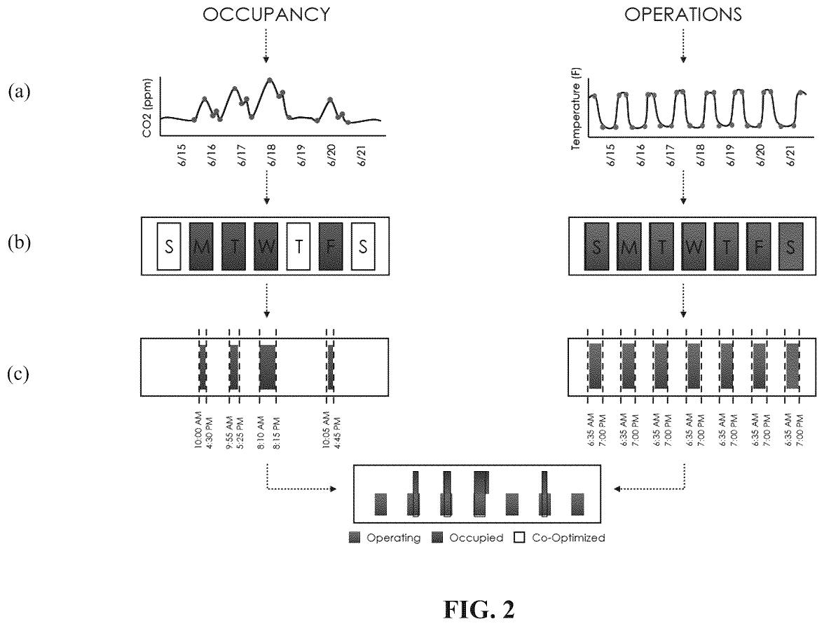

FIG. 2 depicts an example implementation of a system for monitoring indoor air factors of a space, according to one or more aspects described herein. In various implementations, the system may capture and evaluate sensor data indicating occupancy (e.g., CO₂) and operations (e.g., temperature) over a period of time, as depicted in row (a) of FIG. 2. In various implementations, using such sensor data, the system may determine a general weekly occupancy pattern and a general weekly operations pattern, as depicted in row (b) of FIG. 2. In various implementations, the system may then determine daily entry and exit times of daily occupancy for days deemed occupied according to the general weekly occupancy pattern, and determine estimated daily start and end times of daily operation for days deemed as days of operation according to the general weekly operations pattern, as depicted in row (c) of FIG. 2. In various implementations, the system may then use such data to identify time periods representing incidents of extended operations or extended occupancy.

### Estimating Daily Occupancy Start and End Times

In various implementations, occupancy analysis component 116 may be configured to estimate the timing of building occupancy during a given time period. For example, the time of building occupancy may be estimated for each day of the time period. To estimate the timing of building occupancy during a given time period, occupancy analysis component 116 may be configured to determine a general weekly occupancy pattern (e.g., Monday-Friday, Monday-Saturday, or Monday-Sunday) for the building and, for days deemed occupied according to the general weekly occupancy pattern, determine estimated daily entry and exit times of daily occupancy.

In various implementations, occupancy analysis component 116 may be configured to determine a general weekly occupancy pattern for a building and/or estimate daily entry and exit times of daily occupancy based on data obtained via one or more sensors. For example, following the “OCCUPANCY” path depicted in FIG. 2, raw CO₂ data obtained via the one or more sensors may be aggregated to standard 5-minute intervals across a building and smoothed into 15-minute rolling averages. Missing CO₂ values may be filled by linear interpolation. Then, in some implementations, temporal features may be added to the data set. For example, one or more features may include date, year, month, day of week, whether a day may be a holiday, and whether a day may be a weekday or weekend.

In various implementations, smoothed (or cleaned) CO₂ data may be used to generate a daily CO₂ range for each day. For example, daily CO₂ range may comprise an absolute difference between maximum CO₂ value and the minimum CO₂ value. Minimum CO₂ value may be defined as the minimum CO₂ value observed, for example, before 1:00 PM for each day. If the maximum CO₂ value is less than 10% higher than the minimum CO₂ value, the daily CO₂ range may be set to 0 for a day. In some implementations, 25th percentile (Q1), 75th percentile (Q3), and interquartile range (IQR) of CO₂ ranges from non-holiday weekdays may be calculated to produce a baseline from which all other days are compared. An IQR multiplier between 0.5 and 1.5 may be calculated from the mean of all CO₂ ranges for the building over the time period. Then, each day may be assigned unoccupied [if its CO₂ range may be less than the Q1−(IQR multiplier)*IQR] or occupied [otherwise]. Weekends or holidays with CO₂ ranges <100 ppm may be also flagged as unoccupied. Finally, a set of logic may be applied to the proportion of Saturdays and Sundays flagged as unoccupied to determine a general weekly occupancy pattern (i.e., Monday-Friday, Monday-Saturday, or Monday-Sunday) for the building. In some implementations, an operator may override an assigned schedule for a building based on knowledge of actual building occupancy.

In various implementations, occupancy analysis component 116 may be configured to determine estimated daily entry and exit times of daily occupancy for days identified as occupied. For example, in some implementations, occupancy analysis component 116 may be configured to determine estimated daily entry and exit times of daily occupancy for days identified as occupied within system 100. For example, in some implementations, system 100 may be configured to receive user input and/or store information comprising an indication of days in which a building is occupied. In other implementations, occupancy analysis component 116 may be configured to determine estimated daily entry and exit times of daily occupancy for days deemed occupied according to a general weekly occupancy pattern determined by occupancy analysis component 116 as described herein.

In some implementations, occupancy analysis component 116 may be configured to determine estimated daily entry and exit times of daily occupancy using a probabilistic model. For example, occupancy analysis component 116 may be configured to use Gaussian Hidden Markov Model(s) and/or one or more other probabilistic machine learning models to determine estimated daily entry and exit times of daily occupancy. In such implementations, occupancy analysis component 116 may be configured to apply probabilistic model(s) to standardized features derived from smoothed (or cleaned) CO₂ data (e.g., percent deviation of current CO₂ from baseline, the standard deviation of percent deviation from baseline, the first derivative of CO₂ 15-minute rolling averages and its standard deviation, and the rolling standard deviation of CO₂ over 15 minutes). Results may be smoothed (or cleaned) to create reasonable periods of occupancy and then used to pinpoint the daily entry and exit times of daily occupancy for days identified as occupied. In some cases, the exit time may be moved later in the day while the first derivative remains positive and then to any higher CO₂ peaks that occur later in the day, as long as the CO₂ level at the exit time remains above the median of that day's CO₂ levels. Then, occupancy start and end times may be reviewed to remove outlier times and detected occupancy that does not align with the weekly schedule. For days without occupancy start and end times, these values may be imputed in a logically consistent way.

In various implementation, occupancy analysis component 116 may be configured to implement one or more post-processing steps to ensure that all occupied days have logically sound final start and end times, even with challenging or incomplete data. If a day has an occupancy end time but no start time, start time may be set to, as a non-limiting example, 8:00. If a day has an occupancy start time but no end time, the occupancy end time may be set to, as a non-limiting example, 6:00 PM local time. If all occupied days have missing start and end times or if all estimated start times may be exceptionally early (e.g., before 4:00) or if all estimated end times may be exceptionally early (e.g., before 12:00), missing/exceptionally early start/end times may be set to, as a non-limiting example, 8:00 AM and 6:00 PM local time.

Finally, occupancy analysis component 116 may be configured to generate an estimated start and end of occupancy for all days that may be considered as occupied.

In some implementations, occupancy analysis component 116 may be configured to determine estimated daily entry and exit times of daily occupancy by analyzing CO₂ levels, TVOC levels, and/or one or more other parameters. For example, to estimate when occupancy begins, CO₂ (or CO₂ levels) may be assessed to determine if it increases significantly in the morning (e.g., has a statistically significant positive first derivative) after a specified time period (e.g., after 5:00 AM local time). In some implementations, if CO₂ (or CO₂ levels) do not increase significantly in the morning after a specified time period, TVOCs (or TVOC levels) may be assessed to determine if they increase significantly in the morning after the specified time period. If CO₂ (or CO₂ levels) and/or TVOCs (or TVOC levels) do not increase significantly in the morning after a specified time period, CO₂ may be assessed to determine if it increases significantly in the morning (e.g., has a statistically significant positive first derivative) before the specified time period. In some implementations, if CO₂ (or CO₂ levels) do not increase significantly in the morning before or after the specified time period, TVOCs may be assessed to determine if they increase significantly in the morning before the specified time period. In various implementations, to estimate when occupancy ends, CO₂ may be assessed to determine if it decreases significantly in the evening (e.g., has a statistically significant negative first derivative) after a specified time period (e.g., after 4:00 PM local time). In some implementations, if CO₂ (or CO₂ levels) do not decrease significantly in the evening after a specified time period, TVOCs (or TVOC levels) may be assessed to determine if they decrease significantly in the evening after the specified time period. In some implementations, if TVOCs are used as the determining variable for morning or evening but not both, there is no start (if morning) or end (if evening) of occupancy estimated for that day. In other cases, if a statistically significant positive slope is found in the morning, the most extreme significant positive first derivative may be selected, and the start of occupancy may be determined to be the timepoint when the trend that includes the most extreme statistically significant positive first derivative begins. Here, the beginning of a trend may be evaluated using changes in the sign of the first derivative. If a statistically significant negative slope is found in the evening, the end of occupancy may be determined to be the timepoint associated with the most extreme significant negative first derivative. On days where a start of occupancy is estimated, but no end of occupancy is estimated using the methods described herein, the end of occupancy may instead be estimated as the first occurrence of two consecutive negative first derivatives after a given time (e.g., 4:00 PM local time), if this exists in the data. In some implementations, a machine learning approach (for example, using clustering and random forest algorithms) may be applied to CO₂ data to detect changes in CO₂ patterns that may indicate the start and end of occupancy on each day of a time period. For example, in some implementations, a machine learning approach may be used instead of or in addition to other techniques described herein (e.g., using CO₂ and/or TVOC levels) to estimate the start and end of occupancy for a given day of a time period.

### Estimating Daily Operations Start and End Times

In various implementations, operations analysis component 118 may be configured to estimate the timing of building operations during a given time period. For example, the time of building operations may be estimated for each day of the time period. To estimate the timing of building operations during a given time period, operations analysis component 118 may be configured to determine a general weekly operations pattern (e.g., Monday-Friday, Monday-Saturday, Monday-Sunday) for the building and, for days deemed as days of operation according to the general weekly operations pattern, determine estimated daily start and end times of daily operation.

In various implementations, operations analysis component 118 may be configured to determine a general weekly operations pattern for a building based on data obtained via one or more sensors. For example, following the “OPERATIONS” path depicted in FIG. 2, raw temperature data obtained via the one or more sensors may be aggregated to standard 30-minute intervals across a building. Missing temperature values may be filled by linear interpolation. Then, in some implementations, temporal features may be added to the data set. For example, one or more features may include date, year, month, day of week, time of day, whether a day may be a holiday, and whether a day may be a weekday or weekend.

In various implementations, Z-scores for temperatures relative to typical temperatures at a given time of day may be derived at each 30-minute interval. The z-scores may be summarized at the daily level (fraction with an absolute value greater than 2, z-score of fractions with absolute value greater than 2 compared to nearby days), and daily means of z-scores for temperature, daily means of temperature, and the daily standard deviations of temperature may be calculated. In some implementations, K-Means clustering algorithm may be applied to the daily temperature features to identify days that buildings have or do not have any hours of operation. Finally, a set of logic may be applied to the proportion of Saturdays and Sundays flagged as not having hours of operation to determine a general weekly operations pattern (i.e., Monday-Friday, Monday-Saturday, Monday-Sunday). In some implementations, operator may override an assigned schedule for a building based on knowledge of actual building operations.

In various implementations, operations analysis component 118 may be configured to determine estimated daily start and end times of daily operation for days identified as days of operation. For example, in some implementations, operations analysis component 118 may be configured to determine estimated daily start and end times of daily operation for days identified as days of operation within system 100. For example, in some implementations, system 100 may be configured to receive user input and/or store information comprising an indication of days in which a building is operational. In other implementations, operations analysis component 118 may be configured to determine estimated daily start and end times of daily operation for days deemed days of operation according to a general weekly operations pattern determined by operations analysis component 118 as described herein.

In some implementations, operations analysis component 118 may be configured to determine estimated daily start and end times of daily operation using a probabilistic model. For example, operations analysis component 118 may be configured to use Gaussian Hidden Markov Model(s) and/or one or more other probabilistic machine learning models to determine estimated daily start and end times of daily operation. In such implementations, operations analysis component 118 may be configured to apply probabilistic model(s) to standardized features derived from the smoothed (or cleaned) temperature data (e.g., rolling standard deviation of temperature over 1.5 hours; first, second, and third derivatives of temperature and their absolute values; and rolling standard deviations of the derivative values and of the derivative absolute values). Models may be run on all combinations of at least two of these standardized features to determine the optimal set of features for each building, defined as the features that result in model outputs with the lowest variability. Results may be smoothed (or cleaned) to create reasonable periods of operations and then used to pinpoint the daily start and end times of daily operations for days deemed as days of operation by the weekly model. Then, operations start and end times may be reviewed to remove detected operations start or end times that do not align with the weekly schedule. For days without operations start or end times, these values may be imputed in a logically consistent way based on average start and end times from other days during the time period.

In various implementation, operations analysis component 118 may be configured to implement one or more post-processing steps to ensure that all operational days have logically sound start and end times, even in the presence of challenging or incomplete data. If a day has an operations end time but no start time, start time may be set to, as a non-limiting example, 7:00. If a day has an operations start time but no end time, the operations end time may be set to, as a non-limiting example, 19:00. If all days of operation have missing start and end times or if all estimated start times may be exceptionally early/late (e.g., before 2:00/after 12:00) or if all estimated end times may be exceptionally early (e.g., before 14:00), missing/exceptionally early/late start/end times may be set to, as a non-limiting example, 7:00 or 19:00.

Finally, operations analysis component 118 may be configured to generate an estimated start and end of operations for all days that may be considered as days of operation.

In some implementations, operations analysis component 118 may be configured to determine estimated daily start and end times of daily operation by analyzing TVOC levels, temperature levels, and/or one or more other parameters. For example, to estimate when operation begins, TVOCs (or TVOC levels) may be assessed to determine if they increase significantly in the morning (e.g., have a statistically significant positive first derivative) and decrease significantly in the evening (e.g., have a statistically significant negative first derivative). If TVOCs are determined to increase significantly in the morning and decrease significantly in the evening, then the start of operations may be determined to be the timepoint when the trend that includes the most positive statistically significant first derivative begins, and the end of operations may be determined to be the timepoint when the trend that includes the most negative statistically significant first derivative begins. The beginning of a trend may be evaluated using changes in the first derivative and, if necessary, the second or third derivatives. If TVOCs are not determined to both increase significantly in the morning and decrease significantly in the evening, then indoor temperature, indoor RH, indoor PM_{2.5}, and/or other parameters may be evaluated. For example, indoor temperature, indoor RH, and indoor PM_{2.5} may be evaluated in a prioritized order based on the values of their outdoor counterparts. If conditions for one parameter are met, additional parameters are not evaluated. For indoor temperature, indoor RH, indoor PM_{2.5}, and/or other parameters, mornings and evenings may be evaluated independently.

For temperature, operations analysis component 118 may be configured to compare outdoor temperatures in the morning and evening to threshold values to classify the outdoor temperatures as high, neutral, or low. For example, if outdoor temperature in the morning is classified as high, indoor temperature values in the morning may be evaluated to determine if there is a statistically significant decrease (e.g., a statistically significant negative first derivative) in the morning. If outdoor temperature in the morning is classified as low, indoor temperature values in the morning may be evaluated to determine if there is a statistically significant increase. In either case, if there is not a statistically significant slope in the expected direction, the method may look for a statistically significant slope in the opposite direction. If outdoor temperature in the evening is classified as low, indoor temperature values in the evening may be evaluated to determine if there is a statistically significant decrease. If outdoor temperature in the evening is classified as high, indoor temperature values in the evening may be evaluated to determine if there is a statistically significant increase. In either case, if there is not a statistically significant slope in the expected direction, the method may look for a statistically significant slope in the opposite direction. If either the morning or evening outdoor temperature is classified as neutral, the method may look for the most extreme statistically significant slope that is either an increase or a decrease.

For RH, in the morning or evening, the method may look for the most extreme statistically significant slope that is either an increase or a decrease.

For PM_{2.5}, indoor PM_{2.5} values in the morning may be evaluated to determine if there is a statistically significant decrease (e.g., a statistically significant negative first derivative) in the morning. Indoor PM_{2.5} values in the evening may be evaluated to determine if there is a statistically significant increase (e.g., a statistically significant positive first derivative) in the evening. In either case, if there is not a statistically significant slope in the expected direction, the method may look for a statistically significant slope in the opposite direction.

For any of the parameters evaluated, if a statistically significant slope is found in the morning, the most extreme significant first derivative (of the appropriate sign, if relevant) may be selected, and the start of operations may be determined to be the timepoint when the trend that includes the most extreme statistically significant first derivative (of the appropriate sign, if relevant) begins. If a statistically significant slope is found in the evening, the most extreme significant first derivative (of the appropriate sign, if relevant) may be selected, and the end of operations may be determined to be the timepoint when the trend that includes the most extreme statistically significant first derivative (of the appropriate sign, if relevant) begins. The beginning of a trend may be evaluated using changes in the first derivative and, if necessary, the second or third derivatives.

### Health and Energy Co-Optimization

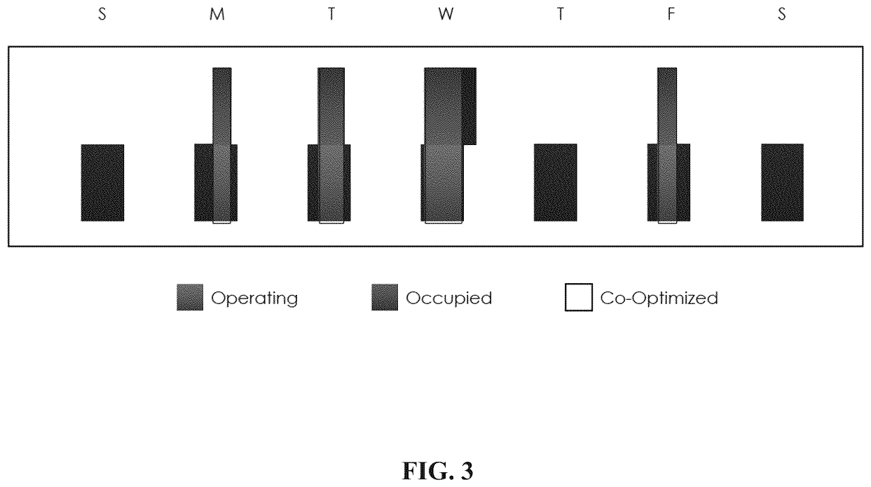

In various implementations, co-optimization component 120 may be configured to analyze estimated daily entry and exit times of daily occupancy determined for days deemed occupied (e.g., according to a general weekly occupancy pattern) alongside estimated daily start and end times of daily operation determined for days deemed as days of operation (e.g., according to a general weekly operations pattern). For example, FIG. 3 depicts a view an example output provided by a system (such as the systems depicted in, and described with respect to, FIG. 1 and FIG. 2) for monitoring indoor air factors of a space, according to one or more aspects described herein. As depicted in FIG. 3, time periods when operations are well-aligned with occupancy may be a sign of effective co-optimization for energy and health. In addition, time periods when operations is out of sync with occupancy may indicate (or highlighting) opportunities for energy savings and health benefits.

In various implementations, co-optimization component 120 may be configured to utilize scoring such that buildings are compared against each other and against respective usage patterns. In some implementations, co-optimization component 120 may be configured to send daily scores during a time period of interest to each building. For example, co-optimization component 120 may send (i) a co-optimization score (characterizing extended operations and occupancy in the morning and evening), (ii) occupancy optimization score (characterizing extended occupancy in the morning and evening), and (iii) operations optimization score (characterizing extended operations in the morning and evening). In some implementations, occupancy optimization score may be a ratio, a duration of extended occupancy to a duration of occupancy for a day or over a continuous usage period. In some implementations, operations optimization score may be a ratio of a duration of extended operations to a duration of operations for a day or over a continuous usage period. Both scores may also be computed dynamically based on the temporal extensions at the start and end of the day: the morning score quantifies the interval between the initial start time of either operations or occupancy and the subsequent start time, while the evening score quantifies the interval between the final end time of either operations or occupancy and the subsequent end time. In some implementations, a combined optimization score may also be defined to represent the total duration of extended operations and extended occupancy relative to the combined duration of operations and occupancy for a day or a continuous usage period.

In various implementations, co-optimization component 120 may be configured to compare, for each day, the estimated start and end hours for operations and the estimated start and end hours for occupancy, and, if they are sufficiently different, the day may be flagged as having extended operations, extended occupancy, both, neither, or inconclusive. If the day is flagged as “neither,” that day may be said to be “co-optimized.” Potential extended operations and potential extended occupancy may also be assigned if ambiguity is present. In some implementations, days with (or identified has having) extended occupancy may be evaluated to determine whether IAQ was suboptimal during periods of extended occupancy. In some implementations, days with (or identified has having) extended occupancy and suboptimal IAQ may be flagged differently than days with extended occupancy where IAQ was optimal. In some implementations, buildings determined to have at least one day with 24/7 operations that does not also have 24/7 occupancy may flagged as such in addition to being flagged as having extended operations.

In various buildings (or zones of interest) where extended occupancy is identified, co-optimization component 120 may review (analyze or determine) IAQ performance indices to determine whether IAQ is suboptimal during periods (i.e., when occupants are expected in the building and/or building monitoring/management systems are turned off or set back). In such implementations, if IAQ performance indices are within targeted (or desirable) threshold values, co-optimization component 120 may not generate recommendations to switch building monitoring/management systems to occupied mode. If IAQ performance indices are not within targeted (or desirable) threshold values, co-optimization component 120 may generate recommendations to switch building monitoring/management systems to occupied mode.

After co-optimization component 120 (or corresponding algorithms) identify periods of extended occupancy where IAQ is suboptimal or periods of extended operations over a time period, co-optimization component 120 may send recommendations to buildings to adjust (or update) a time and/or duration of occupied mode operations. In other implementations, co-optimization component 120 may automatically adjust (or update) building schedules in accordance with a building monitoring/management system that tracks ventilation schedule.

In some implementations, co-optimization component 120 may identify misalignment between building occupancy and operations. For example, co-optimization component 120 may identify potential periods of extended occupancy where IAQ is suboptimal and then integrate such information into building monitoring/management (or automation) system. In certain implementations, co-optimization component 120 may further trigger a building monitoring/management (or automation) system to automatically shift timing of respective occupied/setback mode transition to accommodate the environment during extended occupancy. Similarly, in some implementations, co-optimization component 120 may identify potential periods of extended operations and then integrate such information into building monitoring/management (or automation) system. In certain implementations, co-optimization component 120 may further trigger building monitoring/management (or automation) to automatically shift the timing of its occupied mode/setback mode transition to eliminate periods of extended operations. In various implementations, co-optimization component 120 may automatically track IAQ performance indices to ensure automatic changes did not result in problematic changes in any IAQ parameters that may indicate a suboptimal environment for health.

In various implementations, co-optimization component 120 may further utilize a building energy model (or policy) to correct misalignment between operations and occupancy. In some implementations, co-optimization component 120 may further utilize building energy model (or policy) to estimate energy and/or money savings associated with changes to building operations to correct inefficiencies of building environment management.

In various implementations, co-optimization component 120 may be configured to receive data from one or more IAQ sensors and associated health-based threshold values in a first space of a building. For example, in various buildings (or zones of interest) where extended operations are identified, co-optimization component 120 may receive data from low-cost IAQ sensors and review against associated health-based threshold values to determine whether or how much ventilation rates can be reduced (resulting in energy savings) without sacrificing health of building occupants. In some implementations, co-optimization component 120 may calculate first and second IAQ performance indices based on the data from the one or more IAQ sensors. For example, co-optimization component 120 may calculate mass balance equations to approximate a relationship between ventilation rate and IAQ performance indices to determine how much of changes in ventilation rate would be necessary while keeping IAQ performance indices within targeted (or desirable) threshold values. Co-optimization component 120 (and system 100 generally) may be integrated with or otherwise interact with a monitoring system for monitoring indoor air quality, as described, for example, in U.S. patent application Ser. No. 18/137,979 and/or U.S. patent application Ser. No. 18/338,871, to consider estimated daily entry and exit times of daily occupancy, estimated daily start and end times of daily operation, and indications of IAQ when generating recommendations to switch a mode of, or otherwise adjust, building monitoring/management systems, as described herein.

In some implementations, the methods described herein may include, for each building included or related to the analysis, obtaining measurements related to the area outside or surrounding the building. For example, in some implementations, the methods may utilize measurements of outdoor air temperature, outdoor RH, outdoor PM_{2.5}, and/or other parameters related to the air outside or surrounding the building. Such measurements of outdoor air temperature, outdoor RH, outdoor PM_{2.5}, and/or other parameters may be collected, for example, by a reference monitor or similar device that is placed outdoors in the general vicinity of the building (e.g., at the nearest airport). In some implementations, for each building in the analysis, averages of outdoor temperature, outdoor RH, outdoor PM_{2.5}, and/or other parameters over the selected period of time for the analysis may be obtained. In various implementations, the averages of outdoor temperature, outdoor RH, outdoor PM_{2.5}, and/or other parameters over the selected period of time may be compared against one or more threshold values. In some implementations, the parameters may be ranked according to how often the outdoor data fell outside of the one or more threshold values. For example, the one or more threshold values may include threshold values associated with “action,” “alert,” “limit,” and/or other categories. As used herein, the aforementioned categories may refer to, for example, categories related to certain action(s), performance indicator(s), threshold(s), and/or as otherwise referenced in U.S. patent application Ser. No. 18/137,979 and/or U.S. patent application Ser. No. 18/338,871. In some such implementations, the parameters (i.e., the outdoor temperature, outdoor RH, outdoor PM_{2.5}, and/or other parameter associated with the air outside or surrounding the building) may each be labeled based on their relation to given thresholds such that the parameters can be evaluated in a prioritized order as described previously herein.

In various implementations, results may be presented for one or more buildings (or zones of interest) as a heat map or a set of heat maps that shows each building and the percentage of days over the period of time that each building was co-optimized, had extended occupancy, and/or had extended operations, both overall and/or stratified into morning and evening hours and/or stratified into weekday and weekend hours. In various implementations, results may be displayed in an online platform which may also generate notifications to building personnel if extended operations and/or occupancy reach certain thresholds. In various implementations, results may be integrated automatically into a building management system (BMS) such that building operations could be adjusted automatically to better align operations and occupancy if certain criteria are met.

In some implementations, this system (and corresponding methods) may further include one or more techniques for providing real-time IEQ notifications. These notifications may be aligned with threshold values (or definitions). For example, these notifications may be aligned with threshold values (or definitions) associated with categories, such as health optimized, excellent, action, alert, limit, etc.), as described further in U.S. patent application Ser. No. 18/137,979 and/or U.S. patent application Ser. No. 18/338,871. In various implementations, the real-time IEQ notifications are designed to notify individuals responsible for IEQ in a building when health-relevant suboptimal IEQ conditions may be present. There may be any number of levels (or types) of real-time IEQ notifications. For example, in some implementations, there may be three levels (or types) of real-time IEQ notifications: “action,” “alert,” and “limit. ” In various implementations, an IEQ notification can be triggered for any one of the parameters for which thresholds exist. In some implementations, real-time IEQ notifications may only be triggered during typical occupied hours. In an example implementation, an “action” notification for a sensor may be triggered and become “active” for a parameter when the 1-hour rolling averages (at the raw data interval (e.g., 5 minutes)) of raw measurements of that parameter from that sensor have been in the “action,” “alert,” and “limit” threshold ranges for at least the last 8 hours consistently during typical occupied hours. In an example implementation, an “alert” notification for a sensor may be triggered and become “active” for a parameter when the 1-hour rolling averages (at the raw data interval (e.g., 5 minutes)) of raw measurements of that parameter from that sensor have been in the “alert” and “limit” threshold ranges for at least the last 8 hours consistently during typical occupied hours. In an example implementation, a “limit” notification for a sensor may be triggered and become “active” for a parameter when the 1-hour rolling averages (at the raw data interval (e.g., 5 minutes)) of raw measurements of that parameter from that sensor have been in the “limit” threshold range for at least the last 4 hours consistently during typical occupied hours. In various implementations, once a notification is triggered, it may remain “active” until the notification criteria are not true anymore or until a time at which the end of typical occupied hours has passed. In various implementations, once the notification criteria are false or the end of typical occupied hours has passed, the notification may become “inactive. ” If two notifications are triggered or active simultaneously (e.g., if “limit” and “alert” are both active or “limit” and “action” are both active), the higher severity notification (“limit”) may be triggered or listed as active and the lower severity notification (“alert” or “action”) may be suppressed. In such implementations, when the higher severity notification becomes inactive, the lower severity notification may then be listed as active (if the criteria for that notification are still true at the point in time when the higher severity notification becomes inactive).

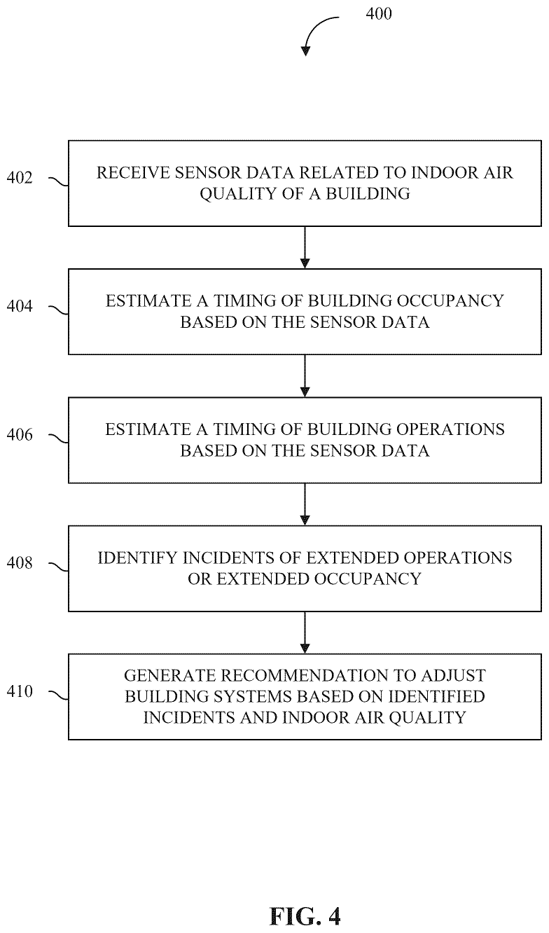

FIG. 4 illustrates an example process 400 for monitoring a building and automatically identifying opportunities for energy savings, according to one or more aspects described herein. The operations of process 400 presented below are intended to be illustrative and, as such, should not be viewed as limiting. In some implementations, process 400 may be accomplished with one or more additional operations not described, and/or without one or more of the operations discussed. In some implementations, two or more of the operations of process 400 may occur substantially simultaneously. The described operations may be accomplished using some or all of the system components described in detail above.

In an operation 402, process 400 may include receiving sensor data indicating one or more parameters related to IAQ of a building for a time period. In various implementations, the sensor data may be received from one or more sensors positioned within and/or around a building. In various implementations, the sensor data may include at least carbon dioxide data and indoor air temperature data for the building. In various implementations, the sensor data may comprise time-dependent sensor data.

In an operation 404, process 400 may include estimating a timing of building occupancy for the building during the time period based on the received sensor data. In various implementations, estimating the timing of building occupancy for the building during the time period may comprise determining a weekly occupancy pattern for the building and determining estimated daily entry and exit times of daily occupancy for days deemed occupied according to the weekly occupancy pattern. In some implementations, determining the weekly occupancy pattern for the building may comprise determining a maximum and minimum daily CO₂ value for each day of the week based on the received sensor data and identifying unoccupied days based on the difference between maximum and minimum daily carbon dioxide values for each day. In various implementations, determining the estimated daily entry and exit times of daily occupancy for days deemed occupied according to the weekly occupancy pattern may comprise applying a probabilistic model to standardized features derived from the received sensor data.

In an operation 406, process 400 may include estimating a timing of building operations for the building during the time period based on the received sensor data. In various implementations, estimating the timing of building operation for the building during the time period may comprise determining a weekly operations pattern for the building and determining estimated daily start and end times of daily operations for days deemed days of operation according to the weekly operations pattern. In various implementations, the weekly operations pattern for the building is determined based on the indoor air temperature data for the building. In various implementations, determining the estimated daily start and end times of daily operations for days deemed days of operation according to the weekly operations pattern may comprise applying a probabilistic model to standardized features derived from the received sensor data. Notably, it would be understood by a person of ordinary skill in the art that operation 404 and operation 406 may occur simultaneously, operation 404 may occur before operation 406, or operation 406 may occur before operation 404. Indeed, the order of at least operations 404 and 406 are not limited based on the order depicted in FIG. 4 or described herein.

In an operation 408, process 400 may include identifying incidents of extended operations or extended occupancy based on a comparison of the estimated timing of building occupancy and the estimated timing of building operations. In an operation 410, process 400 may include generating a recommendation to adjust building systems based on the identified incidents of extended operations or extended occupancy and IAQ performance indicators related to the time period. In various implementations, the recommendation to adjust building systems may include a recommendation to change a mode of building operation at a particular time. In various implementations, the IAQ performance indicators may characterize human health risks of environmental conditions of the building on a health of building occupants.

In various implementations, the method and corresponding system described herein may use data from low-cost IAQ sensors (and, in some implementations, publicly available outdoor temperature, RH, and PM_{2.5} data), with no additional data from building equipment, energy meters, and/or other sources to estimate when a building is operating and/or occupied. The method and system corresponding system described herein may also incorporate occupant health, comfort, and productivity into decisions about when to flag buildings as having potential for energy savings.

As noted previously herein, methods (and techniques) described herein may be implemented in a spatial monitoring system as described, for example, in U.S. patent application Ser. Nos. 18/137,979 and/or 18/338,871. In some implementations, this system (and corresponding methods) may further include one or more techniques for identifying sensors that need maintenance or troubleshooting due to inconsistently or unreliably reporting data during a given period of time. In such implementations, a binary sensor performance score may be generated based on data quality checks for data completeness, variability, and outliers. The binary sensor performance score is designed to identify sensors that need maintenance or troubleshooting due to inconsistently or unreliably reporting data during a given period of time. The results are based on criteria that consider the types of issues (“flags”) found by the data quality check at each sensor and the portion of the period during which the data quality issues occurred. These data quality flags may include reporting unexpected values or values outside of sensor measurement ranges (“outliers”), reporting values with abnormally low variation, and missing data for all or some parameters. Identifying sensors with suboptimal data quality is a key component of providing indoor environmental quality (IEQ) insights because sensors with consistent data quality issues may provide a biased, incomplete, or unrepresentative picture of IEQ in monitored areas of the building. In various implementations, the binary sensor performance score may comprise one of two results: “clear” and “fault. ” A “clear” result may mean that a sensor is generally expected to be working reliably or consistently across a period of time. A “fault” result may mean that data quality check issues that were flagged during a time period occurred for an amount of time that suggests that the sensor is not reporting data consistently or reliably for one or more IEQ parameters and may need maintenance or troubleshooting.

The techniques described herein can be implemented using computing software, firmware, hardware, and/or various combinations thereof. For example, the subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for monitoring a building and automatically identifying opportunities to realize energy savings without comprising the health, comfort, and productivity of building occupants, the method comprising:
receiving sensor data indicating one or more parameters related to indoor air quality (IAQ) of a building for a time period, the sensor data including carbon dioxide data and indoor air temperature data for the building;
determining a weekly occupancy pattern for the building based on the carbon dioxide data;
determining estimated daily entry and exit times of daily occupancy for days deemed occupied according to the weekly occupancy pattern;
determining a weekly operations pattern for the building based on the indoor air temperature data;
determining estimated daily start and end times of daily operations for days deemed days of operation according to the weekly operations pattern;
identifying incidents of extended operations or extended occupancy based on a comparison of the estimated timing of building occupancy and the estimated timing of building operations; and
generating a recommendation to adjust building systems based on the identified incidents of extended operations or extended occupancy and IAQ performance indicators related to the time period.

2. A system for monitoring a building and automatically identifying opportunities to realize energy savings without comprising the health, comfort, and productivity of building occupants, the system comprising:
one or more sensors positioned within and/or around a building;
one or more processors configured by computer readable instructions to:
receive, from the one or more sensors, sensor data indicating one or more parameters related to indoor air quality (IAQ) of a building for a time period;
estimating a timing of building occupancy for the building during the time period based on the received sensor data;
estimating a timing of building operations for the building during the time period based on the received sensor data;
identifying incidents of extended operations or extended occupancy based on a comparison of the estimated timing of building occupancy and the estimated timing of building operations; and
generating a recommendation to adjust building systems based on the identified incidents of extended operations or extended occupancy and IAQ performance indicators related to the time period.

3. The system of claim 2, wherein to estimate the timing of building occupancy for the building during the time period, the one or more processors are configured to:
determine a weekly occupancy pattern for the building; and
determine estimated daily entry and exit times of daily occupancy for days deemed occupied according to the weekly occupancy pattern.

4. The system of claim 3, wherein the received sensor data includes carbon dioxide data for the building, and wherein to determine the weekly occupancy pattern for the building, the one or more processors are configured to:
determine a maximum and minimum daily carbon dioxide value for each day of the week based on the received sensor data; and
identify unoccupied days based on the difference between maximum and minimum daily carbon dioxide values for each day.

5. The system of claim 3, wherein to determine estimated daily entry and exit times of daily occupancy for days deemed occupied according to the weekly occupancy pattern, the one or more processors are configured to apply a probabilistic model to standardized features derived from the received sensor data.

6. The system of claim 2, wherein to estimate the timing of building operation for the building during the time period, the one or more processors are configured to:
determine a weekly operations pattern for the building; and
determine estimated daily start and end times of daily operations for days deemed days of operation according to the weekly operations pattern.

7. The system of claim 6, wherein the received sensor data includes indoor air temperature data for the building, and wherein the weekly operations pattern for the building is determined based on the indoor air temperature data for the building.

8. The system of claim 6, wherein to determine the estimated daily start and end times of daily operations for days deemed days of operation according to the weekly operations pattern, the one or more processors are configured to apply a probabilistic model to standardized features derived from the received sensor data.

9. The system of claim 2, wherein the recommendation to adjust building systems includes a recommendation to change a mode of building operation at a particular time.

10. The system of claim 2, wherein the IAQ performance indicators characterize human health risks of environmental conditions of the building on a health of building occupants.

11. A method for monitoring a building and automatically identifying opportunities to realize energy savings without comprising the health, comfort, and productivity of building occupants, the method comprising:
receiving sensor data indicating one or more parameters related to indoor air quality (IAQ) of a building for a time period;
estimating a timing of building occupancy for the building during the time period based on the received sensor data;
estimating a timing of building operations for the building during the time period based on the received sensor data;
identifying incidents of extended operations or extended occupancy based on a comparison of the estimated timing of building occupancy and the estimated timing of building operations; and
generating a recommendation to adjust building systems based on the identified incidents of extended operations or extended occupancy and IAQ performance indicators related to the time period.

12. The method of claim 11, wherein estimating the timing of building occupancy for the building during the time period comprises:
determining a weekly occupancy pattern for the building; and
determining estimated daily entry and exit times of daily occupancy for days deemed occupied according to the weekly occupancy pattern.

13. The method of claim 12, wherein the received sensor data includes carbon dioxide data for the building, and wherein determining the weekly occupancy pattern for the building comprises:
determining a maximum and minimum daily carbon dioxide value for each day of the week based on the received sensor data; and
identifying unoccupied days based on the difference between maximum and minimum daily carbon dioxide values for each day.

14. The method of claim 12, wherein determining the estimated daily entry and exit times of daily occupancy for days deemed occupied according to the weekly occupancy pattern comprises applying a probabilistic model to standardized features derived from the received sensor data.

15. The method of claim 11, wherein estimating the timing of building operation for the building during the time period comprises:
determining a weekly operations pattern for the building; and
determining estimated daily start and end times of daily operations for days deemed days of operation according to the weekly operations pattern.

16. The method of claim 15, wherein the received sensor data includes indoor air temperature data for the building, and wherein the weekly operations pattern for the building is determined based on the indoor air temperature data for the building.

17. The method of claim 15, wherein determining the estimated daily start and end times of daily operations for days deemed days of operation according to the weekly operations pattern comprises applying a probabilistic model to standardized features derived from the received sensor data.

18. The method of claim 11, wherein the recommendation to adjust building systems includes a recommendation to change a mode of building operation at a particular time.

19. The method of claim 11, wherein the IAQ performance indicators characterize human health risks of environmental conditions of the building on a health of building occupants.
